(19) United States
(12) Patent Application Publication
(10) Pub. No.: US 2021/0356296 A1
(43) Pub. Date: Nov. 18, 2021

(54) DISPLACEMENT SENSOR HAVING A RETURN CORE IN A HOUSING CAVITY

(71) Applicant: Continental Teves AG & Co . oHG, Frankfurt am Main (DE)

(72) Inventor: Frank Grunwald, Frankfurt am Main (DE)

(21) Appl. No.: 17/284,073

(22) PCT Filed: Sep. 9, 2019
(86) PCT No.: PCT/EP2019/073960

§ 371 Date: Apr. 9, 2021

(30) Foreign Application Priority Data
Oct. 12, 2018 (DE) 10 2018 217 517.9

(51) Int. Cl. G01D 5/22

(52) U.S. Cl. CPC G01D 5/2291

(57) ABSTRACT

A displacement sensor for sensing a distance, including an excitation coil for exciting an electromagnetic alternating field, a receiver device for inductively receiving the electromagnetic alternating field and for outputting an output signal which is dependent on the received electromagnetic alternating field. The receiver device has a functional core which is surrounded by at least one receiving coil, and a return core. The return core is designed to shield the functional core from an external electromagnetic field, and the receiver device has a housing with a cavity in which the return core is arranged.

### CROSS REFERENCE TO RELATED APPLICATIONS

This application is the U.S. National Phase Application of PCT International Application No. PCT/EP2019/073960, filed Sep. 9, 2019, which claims priority to German Patent Application No. 10 2018 217 517.9, filed Oct. 12, 2018, the contents of such applications being incorporated by reference herein.

### FIELD OF THE INVENTION

The invention relates to a displacement sensor for sensing a distance, and to a method for producing same.

### BACKGROUND OF THE INVENTION

DE 101 30 572 A1, incorporated herein by reference, discloses an inductive measuring transducer for a displacement sensor which, on the basis of a magnetic field of an encoder element, which is dependent on the position of the encoder element, outputs an electrical signal to an evaluation circuit.

The requirements regarding the robustness of sensors against external magnetic fields have increased significantly in the recent past. In addition, however, the increasing cost pressure must also be countered.

### SUMMARY OF THE INVENTION

It is therefore the aspect of the invention to improve the known displacement sensor or to provide a cost-effective and robust displacement sensor.

According to one aspect of the invention, a displacement sensor for sensing a distance comprises:
an excitation coil for exciting an electromagnetic alternating field,
a receiver device for inductively receiving the electromagnetic alternating field and for outputting an output signal which is dependent on the received electromagnetic alternating field, wherein the receiver device has a functional core which is surrounded by at least one receiving coil. The displacement sensor also has a return core, wherein the return core is designed to shield the functional core from an external electromagnetic field. External magnetic fields are largely conducted past the functional core by the return core and therefore cause only minor interference in the sensor signals. According to an aspect of the invention, the receiver device has a housing with a cavity in which the return core is arranged. The cavity with the return core can be closed with a cover. The electromagnetic alternating field received by the receiver device is influenced preferably by an encoder, in particular a conductive and/or magnetic encoder, depending on its position, and therefore the distance covered by said encoder can be sensed. The output signal then preferably contains information about the distance covered.

In the context of an aspect of the invention, it was recognized that the obvious procedure, in which the two cores are exactly the same and can thus be produced cost-effectively with a single, consistent production process, leads to certain disadvantages, because at least the return core is more complex to produce than appears to be necessary for its function. Owing to the cavity in the housing, the return core can be arranged in said cavity, wherein the material or the structure of the return core can differ from that of the functional core. Thus, no substantial mechanical pressure acts on the return core during production and during operation of the displacement sensor; nevertheless, said return core is mounted safely and in a fixed position by means of the cavity. An aspect of the invention thus permits a more cost-effective and a more robust displacement sensor.

It is preferred that at least one holding element for holding the return core is arranged in the cavity or on a cover of the cavity, the return core being fastened, in particular glued, to said holding element at a distance from one or more walls of the cavity. This serves to avoid tension due to different coefficients of thermal expansion. For this purpose, the return core is fastened in such a manner that it can expand freely in one or all directions without hitting a wall of the cavity. The holding element is preferably in the form of a web or rib. In this case it is in contact with the return core at a point or along a line or is correspondingly glued thereto. The cavity can have a plurality of holding elements, wherein only at least one, that is to say not necessarily all of the holding elements, is fastened fixedly or rigidly to the return core. One or more holding elements can accordingly be in the form of hold-down devices, that is to say can merely restrict the movement of the return core in order, for example, to prevent bending vibrations.

The housing is preferably formed by an injection molding compound which lies against the functional core and envelops the latter. Thus, different methods are used for the mounting of the two cores, said methods in each case meeting the different requirements for the cores or allowing a different configuration of the cores. The injection molding compound can be brought into the corresponding housing shape, including the cavity for the return core, in the course of a transfer molding process. It can also partially include a leadframe with contact legs, said leadframe mechanically supporting the receiver device and simplifying electrical contacting of the displacement sensor.

It is preferred that the injection molding compound comprises a thermosetting material.

According to a preferred embodiment, the functional core comprises an amorphous, in particular substantially magnetostriction-free, alloy. Although this is not as cost-effective as a crystalline core, it makes it possible to expose the functional core to mechanical stresses such as those that occur, for example, when the functional core is overmolded with the injection molding compound of the housing. The functional core can in particular be constructed from a plurality of sheets of the amorphous material.

It is preferred that the return core contains or is composed of a crystalline alloy. While there are only a few magnetostriction-free, magnetic alloys, there is a great number of crystalline materials. This makes it possible to use a cost-effective return core. The cost saving can be more than 60% compared to an amorphous core. Since the permeability of the amorphous functional core used is preferably relatively low, the use of a highly permeable, crystalline return core affords advantages in shielding external magnetic fields, in particular at low frequencies.

It is preferred that the displacement sensor is designed to use an inductive coupling between the excitation coil and the receiver device to sense the distance covered by an encoder, wherein the encoder influences the inductive coupling depending on the distance by local magnetic saturation of the functional core.

The displacement sensor preferably has a circuit on a wiring carrier for receiving the output signal from the receiver device.

According to a further aspect of the invention, a method for producing a displacement sensor comprises:
providing the functional core and the return core,
enveloping the functional core with the housing,
winding the excitation coil and the receiving coil around that part of the housing which contains the functional core,
introducing the cavity into the housing outside that part of the housing around which the excitation coil and the receiving coil are wound,
inserting the return core into the cavity of the housing.

It is preferred that the housing is formed by means of injection molding or transfer molding, wherein the cavity is introduced into the housing by means of a molding tool.

The formation of the housing preferably includes at least partially overmolding the functional core with a protective compound.

The method preferably also includes connecting the receiving coil to electrical connections for outputting the output signal.

### BRIEF DESCRIPTION OF THE DRAWINGS

The above-described characteristics, features and advantages of aspects of this invention and the manner in which they are achieved will become clearer and more distinctly comprehensible in conjunction with the following description of the exemplary embodiments, which will be discussed in more detail in conjunction with the drawings, in which:

FIG. 1 shows a highly schematized operating principle of the displacement sensor,

FIG. 2 shows a highly schematized exemplary embodiment of a displacement sensor according to FIG. 1,

FIG. 3 shows a highly schematized further exemplary embodiment of a displacement sensor according to FIG. 1,

FIG. 4 shows a first production step of a displacement sensor,

FIG. 5 shows a second production step of a displacement sensor,

FIG. 6 shows a greatly simplified, sectioned detailed view of the cavity according to an exemplary embodiment,

FIG. 7 shows a greatly simplified, sectioned detailed view of the cavity according to a further exemplary embodiment.

### DETAILED DESCRIPTION OF THE PREFERRED EMBODIMENTS

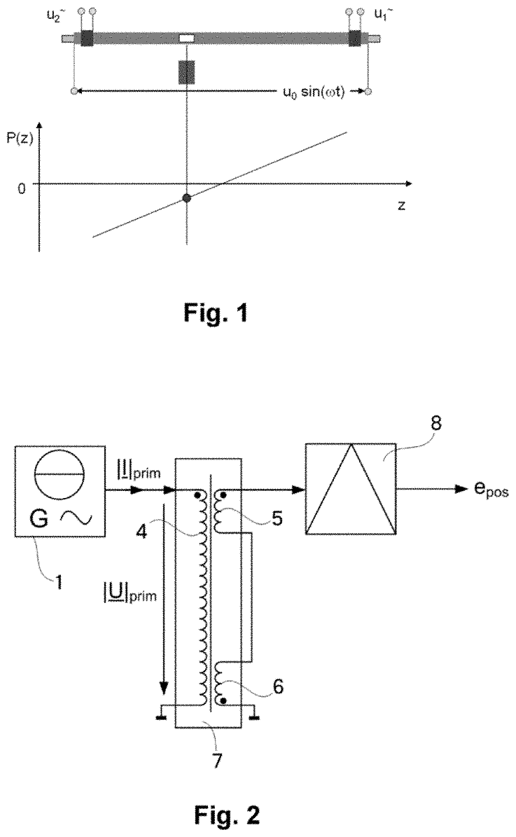

Reference is made to FIGS. 1-3, which show a displacement sensor by way of example in the form of a differential-transformer displacement sensor. The latter derives the measurement variable to be determined, the position of an encoder G, from the difference between two signals induced on the secondary side by an excitation coil 4. The excitation coil 4 and the receiving coils 5 and 6 therefore together form a transformer 7. If a permanent magnet is used as the encoder G, its magnetic field ensures a saturation zone in the soft-magnetic core material K of the functional core 76, said saturation zone for its part weighting the voltages induced on the secondary side proportionally in terms of the position. During normal operation, the permanent magnet which is used as the position encoder G therefore, depending on its position above the soft-magnetic functional core 76, changes the amplitude of the voltages induced in the receiving coils 5, 6. In this description, the term “receiving coil” is used synonymously with the term “inductance” and can therefore also refer to a planar inductance, for example. If the permanent magnet is located in the mechanical center of the transformer, that is to say at the same distance from the two receiving coils 5, 6, the two secondary voltages are equal in absolute value and phase, and the resulting difference is zero.

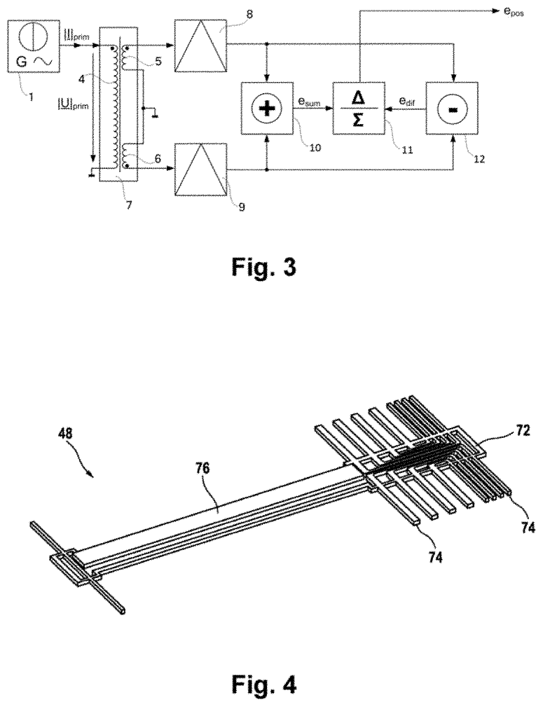

The two types of sensor illustrated in FIG. 2 and FIG. 3 correspond to further exemplary embodiments based on the principle of the displacement sensor illustrated in FIG. 1.

The type I displacement sensor illustrated in FIG. 2 is distinguished by its simple design and, inter alia, by the fact that said displacement sensor determines the position using receiving coils which are connected subtractively. The induced AC variable is subtracted by means of the anti-serial connection of the receiving coils 5, 6, taking into account the winding direction of the respective receiving coil 5, 6, wherein the position information can be determined without errors over the entire measuring range only if the absolute value and phase of the induced signals in the receiving coils 5, 6, i.e. the secondary signals, are taken into account. The AC voltage amplitude which has been obtained subtractively is rectified with an amplitude demodulator 8, which is embodied as a phase-sensitive rectifier which also takes into account the phase component. The actuation signal of the excitation coil 1 is generally used as a reference phase position.

In the type I sensor, position-dependent phase errors of the transformer 7 in relation to the reference phase position of the actuation of the excitation coil 1 directly influence the accuracy of the resulting position information which is produced as a sensor output signal epos at the output of the demodulator 8.

For a sufficiently linearly extending position characteristic curve, the source which actuates on the excitation-coil side, i.e. on the primary side, should be embodied as a power source of constant amplitude in the case of the type I sensor. This should be considered disadvantageous because in comparison with a generator with a constant voltage amplitude the expenditure on circuitry for a constant AC power source is generally higher. The direct dependence of the position variable on the absolute amplitude of the current which actuates on the primary side is also disadvantageous. In order to avoid inaccuracies in the position signal, a primary source which is highly stable with respect to the amplitude of the current is necessary. Compensation through a ratiometric mode of operation is not present in this respect in the type I sensor. Since, due to its simple design, the type I sensor makes it virtually impossible to compensate for systematic errors occurring during the measuring process, it should be used only for simpler applications with less stringent requirements.

Type II displacement sensors, as illustrated in FIG. 3, differ from the above-mentioned type I sensor primarily in the manner in which the secondary signals are evaluated. Two amplitude demodulators 8, 9 are used which selectively form the amount of the alternating voltage induced in the receiving coil 5, 6 for each receiving coil 5, 6. The phase information can be dispensed with. The further processing of the absolute values which are obtained for the secondary amplitudes relating to the position information is done by applying the arithmetic operations of a difference formation operation 12 and a sum formation operation 10. Finally, the position signal epos is obtained with the formation of the quotient 11 from the differential signal edif and the sum signal esum. The signal processing often takes place in a purely digital fashion starting from the inputs of the amplitude demodulators 8, 9. As a result, type II displacement sensors are particularly low in drifting when changes occur in the ambient temperature and are additionally particularly stable over the long term. The increased outlay involved in the type II sensor also includes other advantages:

an easy-to-configure AC voltage generator with a preferably constant amplitude can be used without disadvantages as an actuation signal source 1 of the excitation coil. This is possible because the quotient formation operation 11 is used to standardize the sum amplitude for each individual measuring point on the position axis. This provides the advantages that the primary amplitude can no longer have any influence on the position value epos which is obtained. In addition, the applied standardization method contributes to significant characteristic curve linearization despite the primary voltage source which is used. With the esum and edif variables, not only is the position information available but also further variables which can be used for error diagnostic purposes, without entailing additional costs. Since type II sensors are independent of the absolute primary amplitude and of the non-evaluated phase information and therefore also cannot make an incorrect contribution, such sensors are suitable for applications with relatively stringent requirements.

To produce the displacement sensor, a leadframe 72 with contact legs 74 can be punched out for the first production state, said leadframe mechanically supporting the differential transformer on the above-mentioned wiring carrier 42 and making electrical contact with said differential transformer by way of the circuit 38 on the wiring carrier 42. For the sake of clarity, only a few of the contact legs 74 are provided with a reference symbol in FIG. 4.

A functional core 76, which is later provided for transmitting a magnetic field between excitation and receiving coils 4, 5, 6, is then arranged in the leadframe 72.

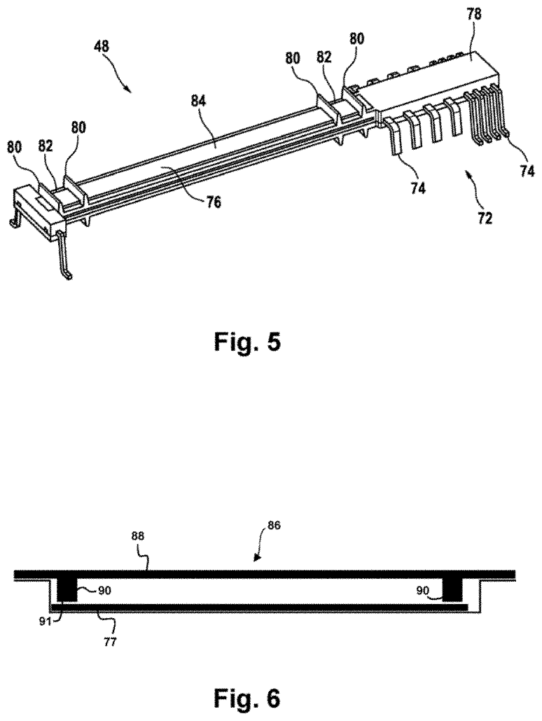

Reference is made to FIG. 5, which shows the differential transformer 48 in the displacement sensor from FIG. 4 in a second production state.

To produce the second production state shown in FIG. 5, the leadframe 72 with the magnetic functional core 76 is enveloped with a protective compound 78. In the present embodiment, this protective compound 78 is composed of thermosetting material, which ideally has substantially the same coefficient of expansion as the magnetic functional core 76. In the event of temperature fluctuations, hardly any mechanical stresses are thus introduced into the magnetic functional core 76.

The protective compound 78 is formed here with four separating elements 80 that divide the magnetic functional core 76 into two outer winding regions 82 and one inner winding region 84. The outer winding regions 82 are shorter than the inner winding region 84.

Subsequently, when the protective compound 78 has hardened, for example, the contact legs 74 can then be bent, as shown in FIG. 5, in the direction of an underside of the differential transformer 48.

In order to be able to arrange not only the functional core 76 but also the return core 77 in the displacement sensor, during the transfer molding process a recess or cavity 86 is formed into which the return core is then inserted. The cavity 86 is then closed with a cover 88, for example glued or screwed. The return core 77 is composed of a cost-effective crystalline material, since it is not exposed to the injection pressure in the cavity, like the functional core 76.

To complete the differential transformer 48, coil wires (not illustrated specifically) are wound into the winding regions 82, 84 on the differential transformer. An excitation coil is wound up here over all the winding regions 82, 84, while a receiving coil, in each case structurally identical to one another, is wound up into each one of the outer winding regions 82.

In FIG. 6, the cavity 86 in the housing formed from the protective compound 78 is illustrated as a sectional view. The cover 88, with which the cavity 86 is closed, is equipped with two holding elements 90. At the end of the one holding element 90 there is an adhesive point 91 to which the return core 77 is glued at one end. The other end of the return core is held in position by the other holding element 90. The cavity 86 is dimensioned in such a manner that at both ends of the return core 77 there remains enough distance from the walls of the cavity that the return core 77 can expand thermally. In addition, the return core 77 is also spaced apart over its longitudinal extent from the cavity 86.

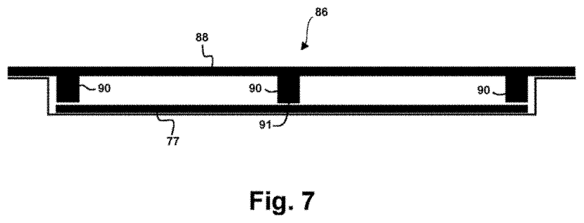

Another possibility is illustrated in FIG. 7. In this exemplary embodiment, a holding element 90 is arranged centrally and provides the adhesive point 91 to which the return core 77 is fastened. The lever arms up to the ends of the return core 77 are shorter than in the exemplary embodiment in FIG. 6. At the ends, a movement of the return core 77 is restricted by further holding elements 90 which, however, do not have any adhesive points 91.

1. A displacement sensor for sensing a distance, comprising:
an excitation coil for exciting an electromagnetic alternating field, and
a receiver device for inductively receiving the electromagnetic alternating field and for outputting an output signal which is dependent on the received electromagnetic alternating field,
wherein the receiver device has a functional core which is surrounded by at least one receiving coil, and a return core, wherein the return core is designed to shield the functional core from an external electromagnetic field, and wherein the receiver device has a housing with a cavity in which the return core is arranged.

2. The displacement sensor as claimed in claim 1, wherein at least one holding element for holding the return core is arranged in the cavity or on a cover of the cavity, the return core being fastened to said holding element at a distance from one or more walls of the cavity.

3. The displacement sensor as claimed in claim 1, wherein the housing is formed by an injection molding compound which lies against the functional core and envelops the latter.

4. The displacement sensor as claimed in claim 3, wherein the injection molding compound comprises a thermosetting material.

5. The displacement sensor as claimed in claim 3, wherein the functional core comprises an amorphous, magnetostriction-free, alloy.

6. The displacement sensor as claimed in claim 1, wherein the return core contains or is composed of a crystalline alloy.

7. The displacement sensor as claimed in claim 1, wherein the displacement sensor is designed to use an inductive coupling between the excitation coil and the receiver device to sense the distance covered by an encoder, wherein the encoder influences the inductive coupling depending on the distance by local magnetic saturation of the functional core.

8. The displacement sensor as claimed in claim 1, further comprising a circuit on a wiring carrier for receiving the output signal from the receiver device.

9. A method for producing a displacement sensor as claimed in claim 1, comprising:
providing the functional core and the return core,
enveloping the functional core with the housing,
winding the excitation coil and the receiving coil around that part of the housing which contains the functional core,
introducing the cavity (86) into the housing outside that part of the housing around which the excitation coil and the receiving coil are wound, and
inserting the return core (77) into the cavity (86) of the housing.

10. The method as claimed in claim 9, wherein the housing is formed by injection molding or transfer molding, wherein the cavity (86) is introduced into the housing by a molding tool.

11. The method as claimed in claim 9, further comprising overmolding the functional core (76) at least partially with a protective compound (64) to form the housing.

12. The method as claimed in claim 9, further comprising connecting the receiving coil (5) to electrical connections (74) for outputting the output signal.

13. The displacement sensor as claimed in claim 2, wherein the housing is formed by an injection molding compound which lies against the functional core and envelops the latter.

14. The displacement sensor as claimed in claim 4, wherein the functional core comprises an amorphous, magnetostriction-free, alloy.

15. The method as claimed in claim 10, further comprising overmolding the functional core at least partially with a protective compound to form the housing.
